(19) United States
(12) Patent Application Publication
(10) Pub. No.: US 2015/0096444 A1
(43) Pub. Date: Apr. 9, 2015

(54) NONWOVEN FELT WITH HOLLOW SPECIALTY POLYMER FIBERS FOR AIR FILTRATION

(71) Applicant: BHA Altair, LLC, Franklin, TN (US)

(72) Inventors: Todd Joseph Scheerer, Lee's Summit, MO (US); Vishal Bansal, Overland Park, KS (US)

(73) Assignee: BHA Altair, LLC, Franklin, TN (US)

(21) Appl. No.: 14/045,849

(22) Filed: Oct. 4, 2013

(51) Int. Cl. B01D 53/22

(52) U.S. Cl. CPC B01D 53/228
USPC 96/7; 96/10; 96/4; 96/14; 96/11

(57) ABSTRACT

An air filter assembly includes a felt of hollow specialty polymer fibers having nonporous walls.

### BACKGROUND OF THE INVENTION

The subject matter disclosed herein generally relates to nonwoven fabrics used as air filtration media and more particularly to air filtration media made of nonwoven felts using hollow fibers made of specialty polymers.

Filtration is a mechanism for separating one substance from another by entrapment within or on the matrix structure of a filter medium. Many industries have a need for air filtration, i.e. the removal of unwanted particles from air. A typical air filter assembly includes a felt of nonwoven fabric formed into a bag. Felts are nonwoven, unbonded fibrous structures deriving coherence and strength from interfiber entanglement and their accompanying frictional forces. Felt materials have good dimensional stability and can be made with a wide variety of natural or synthetic fibers to withstand the mechanical, chemical and thermal requirements demanded by the application.

Due to costs and the extreme physical and chemical environment that some filters must endure, any improvement in the durability, filtration efficiency, chemical resistance, weight and resilience from compression is desired. Stability of the filter media at higher operating temperatures is also a desirable feature of filters. Companies that use filtration media formed with specialty polymers face a problem of balancing performance and cost. Components of costs of filter assemblies include material costs, and costs of shipping the entire assembly. Any reduction in the amount of materials and weight provides an advantage to users of filtration media.

Air filters are currently made from uniform solid fibers. Hollow fibers produced with polymers exist for non-analogous uses such as in insulation and apparel, but are not used in air filtration media. Hollow fiber membranes for liquid filtration are also known. However, hollow fiber membranes for liquid filtration have a porous semipermeable wall.

### BRIEF DESCRIPTION OF THE INVENTION

The disclosure provides a filter assembly including felt having lower material content thereby reducing the material costs and weight of a filter assembly.

In accordance with one exemplary non-limiting embodiment, the invention relates to an air filter assembly including a felt of hollow specialty polymer fibers having nonporous walls.

In another embodiment, an air filter media is provided having a felt of hollow specialty polymer fibers having nonporous walls.

In another embodiment, a filter made of a nonwoven spunbond fabric having a plurality of hollow, nonporous, continuous filaments made of a specialty polymer is provided.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 is a schematic representation of an interlocking web of microfibers for use as a filter medium.

FIG. 2 is a cross section view of a hollow microfiber used in a filter medium.

FIG. 3 illustrates various cross sections of hollow fibers.

### DETAILED DESCRIPTION OF THE INVENTION

Traditionally, fibers used in filtration media have a solid cross-section. Use of a hollow fiber cross-section in filtration media would allow for lower cost and weight due to a reduction in the polymer.

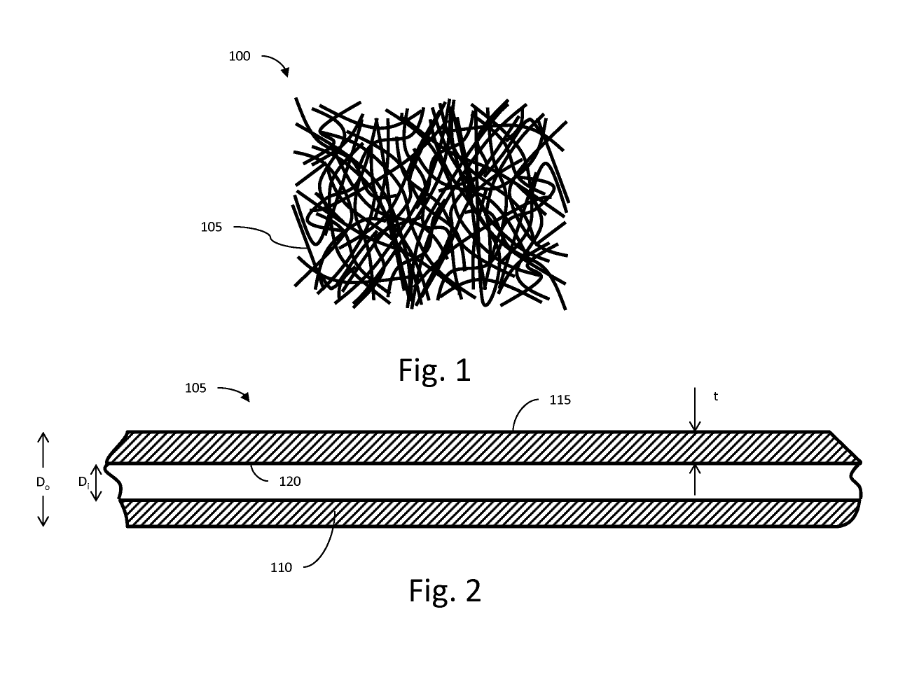

Illustrated in FIG. 1 is an embodiment of an interlocking web of hollow microfibers 100 forming a felt having a plurality of individual hollow microfiber(s) 105. FIG. 2 illustrates an individual hollow fiber 105 having a nonporous polymer wall 110 with an exterior surface 115 and an interior surface 120. The exterior surface 115 of the nonporous polymer wall 110 has an outer diameter Dₒ of between 5 to 100 microns. The individual hollow fiber 105 has an interior diameter D. The wall thickness “t” of the individual hollow fiber 105 may be between 5 to 80% of the outer diameter Dₒ.

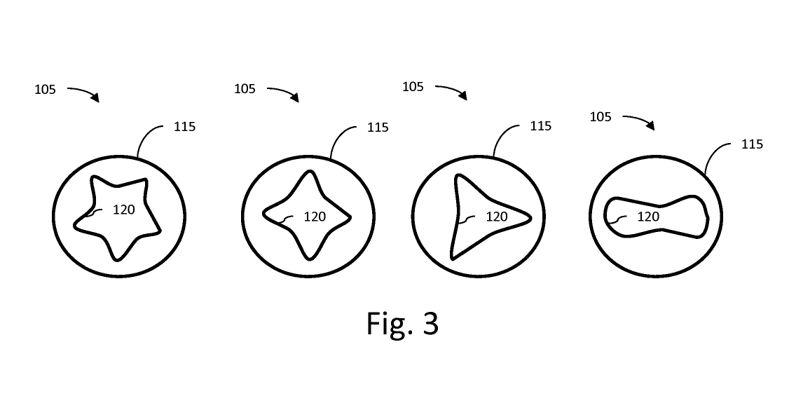

Although in the foregoing example, the fiber is described as having a single circular cavity, other shapes may be used, such as for example, those illustrated in FIG. 3. Additionally, the cross section of the fiber may be of shapes other than cylindrical shapes.

In one application, the individual hollow microfiber(s) 105 are made of specialty polymers such as polyphenylsulfide, aramids, polyetherimide, polyethersulfone, polysulfone, polytetrafluoroethylene, acrylics, and copolymers thereof

The hollow microfiber(s) 105 for filtration media may be extruded as a solution or melt spun polymer through a spinneret to form a tube.

Hollow microfiber(s) 105 offer higher strength per unit weight and also provide more resilience from compression when compared with solid fibers. For example, hollow trilobal fibers with same outer diameter have about 14% higher tensile strength, and 16% higher tensile modulus. (“Influence of the Cross-Sectional Shape on the Structure and Properties of Polyester Fibers”, Journal of Applied Polymer Science, Vol. 103, pg. 2615, (2006))

The hollow microfiber(s) may be made into a felt that provides a lower weight felt for the same filtration surface area. For example, a felt made from 3 denier hollow polyester fibers with 50% void (based on volume) will have about 42% lower weight (for same filtration area) as compared to a felt made from 3 denier solid polyester fibers. Denier is a unit of measure for the linear mass density of fibers. It is defined as the mass in grams per 9000 meters. The felt may be laminated to a suitable substrate.

The hollow microfiber(s) 105 may be made into a spunbond fabric. The spunbond fabric is a nonwoven fabric composed of thermally bonded, continuous, nonporous specialty polymer hollow filaments. The spunbond fabric is produced by depositing extruded, spun hollow filaments onto a collecting belt in a uniform random manner. The fibers may be separated during the web laying process by air jets or electrostatic charges. After the hollow filaments are collected, the fibers are bonded. A variety of methods may be used to bond the microfiber(s) in a spun web. Among these methods are mechanical needling, thermal bonding, and chemical bonding. The hollow microfiber(s) 105 may be laminated to a suitable substrate.

Where the definition of terms departs from the commonly used meaning of the term, applicant intends to utilize the definitions provided below, unless specifically indicated.

The terminology used herein is for the purpose of describing particular embodiments only and is not intended to be limiting of the invention. Where the definition of terms departs from the commonly used meaning of the term, applicant intends to utilize the definitions provided herein, unless specifically indicated. The singular forms “a”, “an” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. An air filter assembly comprising:
a felt of hollow specialty polymer fibers having nonporous walls.

2. The air filter assembly of claim 1, wherein the felt of hollow specialty polymer fibers comprises hollow fibers made from a polymer selected from among a group comprising polyphenylsulfide, aramids, polyetherimide, polyethersulfone, polysulfone, polytetrafluoroethylene, acrylics, and copolymers thereof

3. The air filter assembly of claim 1, wherein the felt of hollow specialty polymer fibers are between 5 microns to 100 microns in diameter.

4. The air filter assembly of claim 1, wherein the felt of hollow specialty polymer fibers are extruded as a solution through a spinneret.

5. The air filter assembly of claim 1, wherein the felt of hollow specialty polymer fibers are extruded as melt spun polymer through a spinneret.

6. The air filter assembly of claim 1, wherein the felt of hollow specialty polymer fibers comprise fibers having a predetermined outer diameter and a wall thickness of between 5% to 80% of the predetermined outer diameter.

7. The air filter assembly of claim 1, wherein the felt of hollow specialty polymer fibers is laminated to a substrate.

8. An air filter media comprising:
a felt made of a plurality of hollow fibers having nonporous walls made of a specialty polymer.

9. The air filter media of claim 8, wherein the plurality of hollow fibers comprise a plurality of hollow fibers made from a polymer selected from among a group comprising polyphenylsulfide, aramids, polyetherimide, polyethersulfone, polysulfone, polytetrafluoroethylene, acrylics, and copolymers thereof

10. The air filter media of claim 8, wherein each of the plurality of hollow fibers is between 5 microns to 100 microns in diameter.

11. The air filter media of claim 8, wherein each of the plurality of hollow fibers is extruded as a solution through a spinneret.

12. The air filter media of claim 8, wherein each of the plurality of hollow fibers is extruded as melt spun polymer through a spinneret.

13. The air filter media of claim 8, wherein each of the plurality of hollow fibers has a predetermined outer diameter and a wall thickness between 5% to 80% of the predetermined outer diameter.

14. A filter comprising a nonwoven spunbond fabric having a plurality of hollow continuous nonporous filaments made of a specialty polymer.

15. The filter of claim 14 wherein each of the plurality of hollow continuous nonporous filaments made of a specialty polymer is made of a polymer selected from among a group comprising polyphenylsulfide, aramids, polyetherimide, polyethersulfone, polysulfone, polytetrafluoroethylene, acrylics, and copolymers thereof

16. The filter of claim 14 wherein the spunbond fabric is laminated to a substrate.

17. The filter of claim 14 wherein each of the plurality of hollow continuous nonporous filaments is between 5 microns to 100 microns in diameter.

18. The filter of claim 17 wherein each of the plurality of hollow continuous nonporous filaments has a wall thickness of between 5% to 80% of the diameter.

19. The filter of claim 14, wherein some of the plurality of hollow continuous nonporous filaments are thermally bonded.

20. A plurality of hollow specialty polymer fibers with nonporous walls made from a polymer selected from among a group comprising polyphenylsulfide, aramids, polyetherimide, polyethersulfone, polysulfone, polytetrafluoroethylene, acrylics, and copolymers thereof.
